(19) United States
(12) Patent Application Publication
(10) Pub. No.: US 2003/0039123 A1
(43) Pub. Date: Feb. 27, 2003

(54) Motor vehicle safety system

(76) Inventor: William E. Crisick, Walnut Creek, CA (US)

Correspondence Address: William E. Crisick, 3593 Whitehaven Drive, Walnut Creek, CA, 94598, US

(21) Appl. No.: 09/910,273

(22) Filed: Jul. 19, 2001

(51) Int. Cl. B60Q 1/00

(52) U.S. Cl. 362/464

(57) ABSTRACT

This invention comprises an improvement to motor vehicle lighting systems which enhances the safe operation of motor vehicles by communicating the operational state of the vehicle to operators of nearby vehicles. The system comprises an array of sensors to detect the operational condition of various components of a motor vehicle, and a computer which analyzes the outputs of the sensors, determines the operational state of the vehicle, and controls various displays which communicate the operational state information.

### CROSS-REFERENCE TO RELATED APPLICATIONS

Not Applicable.

### BACKGROUND—FIELD OF THE INVENTION

The present invention relates to motor vehicle safety and lighting systems, and in particular to systems and methods for communicating information regarding the operational state of a vehicle to drivers of nearby vehicles.

### BACKGROUND—DISCUSSION OF PRIOR ART

Current standards in lighting devices on motor vehicles are well established in both practice and law as typically headlights for illuminating the roadway ahead and red tail-lights for conspicuity when operating during darkness; brake lights that illuminate in response to application of the vehicle's brakes; and flashing turn indicators, the operation of which is initiated by the vehicle operator. Most vehicles are equipped with additional lights of various sizes and types, for example, backup lights, parking lights, clearance lights on trucks, and the like. In general, state and federal laws require some minimum combination of these lights for legal operation on public roadways. For example, the California Vehicle Code in Section 12 specifies that vehicles must have headlamps, tail lamps, and stop [brake] lamps, and that certain other types of lamps such as those mentioned earlier herein are permissible, The California Code further specifies certain other requirements, among which are visibility standards, but none of which are germane to this discussion.

Existing practice for the indication of vehicle braking is limited to either of two conditions, brakes applied, in which case the brake lights are illuminated, or brakes off, in which case the brake lights are off.

To determine whether a nearby vehicle is accelerating, moving at constant velocity, or decelerating without the aid of brakes, the driver of a nearby vehicle must employ visual observation of the subject vehicle, mental analysis, and the drawing of conclusions from the observations and analysis. With respect to braking, the driver of a following vehicle can only determine that the leading vehicle's brakes are applied or are off, and has no information regarding the rate of deceleration due to braking. To evaluate the rate of deceleration due to braking, the driver of the following vehicle must again employ visual observation, mental analysis, and the drawing of conclusions from the observation and analysis. While drivers have come to be comfortable with the limited amount of information available with present systems and practices it is clear that additional information would greatly contribute to the safe operation of motor vehicles.

Thus it may be seen that current practices in vehicle lighting systems provide only a minimum capability of informing other drivers as to the operational state of a vehicle. Further, there is no way, with present practices, of communicating to other drivers the deceleration rate of a vehicle. This inevitably leads to drivers in traffic being unaware when the vehicle in front of them begins to slow, and uninformed as to how rapidly the leading vehicle is decelerating when the brakes of that vehicle are applied. The result is an inordinately higher likelihood of rear-end collisions, and the resultant personal injury, property damage, expenditure of community emergency response and law enforcement resources, and environmental damage from the release of toxic materials when automotive systems rupture following a collision.

As vehicular traffic increases with increasing population and mobility, and as more highways implement higher speed limits, this problem will become increasingly more acute.

### BACKGROUND—DISCUSSION OF PRIOR PATENTED ART

A search of the United States Patent & Trademark Office Patent Database found no prior patents with the combination of US Classifications 180/271—Motor vehicle safety promoting means, and 362/61—Vehicle lighting systems. Applicant reviewed 167 patents having US Classification 180/271 or 362/61 and the word ‘light’ in the specification, and found no relevant patented art.

Applicant is unaware of any prior published literature on the subject of vehicle lighting systems that bears on the present invention.

### BRIEF SUMMARY OF THE INVENTION

The invention disclosed herein is an improvement to existing motor vehicle lighting systems comprising a new and novel combination which significantly enhances the safe operation of motor vehicles by communicating information on the operational state of a vehicle to drivers of nearby vehicles and in particular to drivers of following vehicles. The principle elements of the invention are sensing devices to determine the operational state of key component systems of the vehicle, and a computer to gather information from the sensing elements, process that information according to pre-programmed algorithms and predetermined logic rules, and actuate various lights or other types of display or warning devices on the vehicle so as to communicate to drivers of nearby vehicles the operational state of the subject vehicle.

### OBJECTS AND ADVANTAGES OF THE INVENTION

Accordingly, several objects and advantages of the present invention are:

(a) To provide a safety system for motor vehicles that informs drivers of nearby vehicle about the operational state of the subject vehicle;

(b) To provide a safety system that informs drivers of nearby vehicles regarding the rate of deceleration due to braking of the subject vehicle;

(c) To provide a safety system that contributes to the reduction of collisions between motor vehicles, in particular rear-end collisions;

(d) To provide a safety system that contributes to the reduction of injury, pain and suffering, and death of drivers and passengers in motor vehicles;

(e) To provide a safety system that reduces societal costs for such things as motor vehicle insurance, motor vehicle repairs, state and municipal law enforcement and emergency response agencies, lost productive time of workers, and others.

(f) To provide a safety system that contributes to the protection of the environment by reducing the release of hazardous materials from various automotive systems such as the cooling system, the engine lubrication system, the braking system, batteries, the fuel system, and others when these systems rupture following a collision.

Further objects and advantages of this invention will become apparent to the reader from a consideration of the ensuing description.

### DESCRIPTION OF DRAWING FIGURES

FIG. 1 is a schematic representation of a conventional motor vehicle with a front mounted reciprocating internal combustion engine and rear wheel drive, showing the key components thereof and placement of sensors and displays thereon.

FIG. 2 shows a possible embodiment of the display lights of the safety system.

FIG. 3 is a single-line block diagram showing the sensors and displays and their respective interconnections with the computer.

### LIST OF REFERENCE NUMERALS IN DRAWINGS

10 Engine

15 Engine speed sensor

20 Intake manifold

25 Vacuum sensor

26 Throttle position sensor

30 Transmission

35 Transmission sensor

40 Drive train

45 Vehicle speed sensor

50 Braking system

55 Brake sensor

60 Clutch mechanism

65 Clutch position sensor

70 Display housing

71 Green light

72 Red light

73 Yellow light

80 Computer

### DESCRIPTION OF THE INVENTION

This invention employs existing devices and technology well known to practitioners of the art of motor vehicle design in an innovative new and novel combination and configuration so as to achieve the objects of the invention. The purpose and function of each element of the new combination is discussed below.

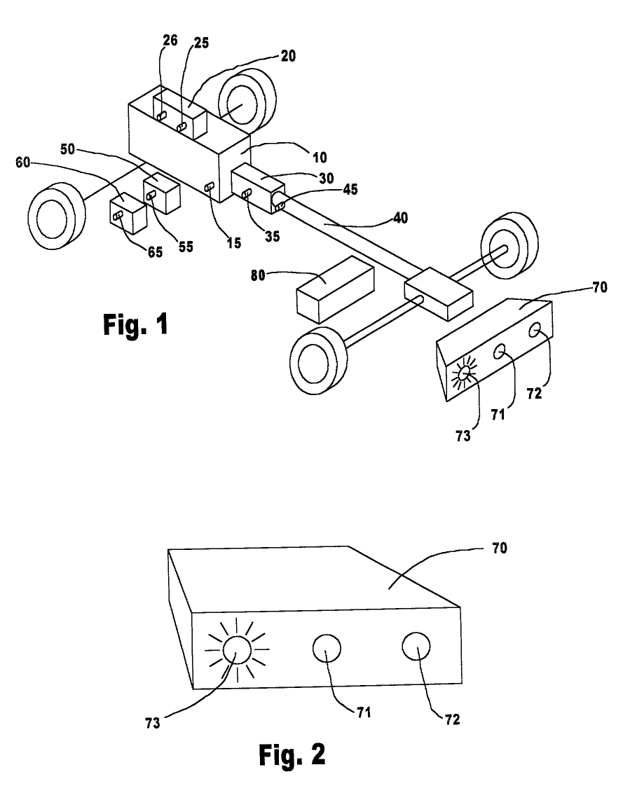

Referring to FIG. 1, engine speed sensor 15 and vacuum sensor 25 determine in cooperation with computer 80 whether engine 10 is (a) idling; (b) increasing in speed and power output; (c) operating at constant speed and power output thereby maintaining constant vehicle velocity; or (d) operating at a power setting at which the vehicle will decelerate. In an internal combustion gasoline engine, for example, these parameters are easily determined by measuring engine intake manifold vacuum by means of a vacuum transducer, and engine speed (revolutions per minute) by means of a tachometer associated with the ignition system. In a diesel engine the engine speed tachometer could be associated with the fuel injection system or it could be an electromechanical tachometer associated with the flywheel of the engine.

Optional throttle position sensor 26 determines the position of the throttle and thus whether or not the operator desires more or less power from engine 10. This sensor may be associated with the accelerator pedal, for example, or with the throttle linkage and mechanisms that control engine 10. This sensor is optional. If it is used the computer logic must be changed appropriately.

Brake sensor 55 determines the force being applied by the operator to the vehicle service braking system 50. This sensor will typically be a pressure transducer that produces an output signal directly proportional to the pressure in the braking system as a proxy for the rate of vehicle velocity reduction desired by the operator. For purposes of brevity hereafter, a reference to brakes or braking system implies the vehicle service brakes as opposed to the parking brake.

Vehicle speed sensor 45 determines the speed of the vehicle, and, in cooperation with computer 80, whether the vehicle is accelerating, operating at constant velocity, or decelerating. This sensor can utilize a take-off from the vehicle speedometer drive mechanism as its input, or may be a separate tachometer associated with vehicle drive train 40.

In vehicles with a manual shift transmission clutch position sensor 65 is required. This sensor determines whether or not the clutch pedal or other actuator (for example, a hand lever on a motorcycle) is depressed. Clutch actuator movement from the rest position is considered to indicate that the clutch is disengaged, and the operational state defaults to stopped and idling.

In vehicles with an automatic transmission, transmission sensor 35 would serve a function similar to that of the clutch sensor, i.e., if the transmission is not in a forward gear the operational state would default to stopped and idling.

As diagramed in FIG. 3, the output of each sensor is directed to computer 80. Computer 80 evaluates the information received from the sensors and determines the operating state of the vehicle according to a pre-determined and pre-programmed set of logic rules. For example:

The relative power output of engine 10 may be determined by comparing the output from vacuum sensor 25 to stored data on the performance characteristics of engine 10.

Differentiation of the output of engine speed sensor 15 by computer 80 determines whether engine speed is increasing, constant, or decreasing.

The relative percent of braking may be determined by comparing the pressure in braking system 50, as measured by brake sensor 55, to stored data on the braking system design characteristics.

Differentiation of the output of vehicle speed sensor 45 by computer 80 determines whether the vehicle is accelerating, operating at constant velocity, or decelerating.

Computer 80 also controls various display devices, typically but not necessarily, lights on the vehicle, and activates one of the display devices, for example, green light 71, yellow light 73, or red light 72, according to the operating state of the vehicle, so that drivers of other vehicles in the vicinity are made aware of the operating state of the subject vehicle.

In practice the functions of computer 80 of this invention could easily be integrated into one or several of the existing computers commonly employed in vehicles being produced today.

### DESCRIPTION OF OPERATION OF THE PREFERRED EMBODIMENT

The number of possible embodiments of this invention is virtually limitless in terms of the quantity, color and placement, and the combinations of color and placement, of lights on a vehicle, as is evident from the proliferation of lighting designs on modern day motor vehicles. Further, the number of possible embodiments of signs and other types of displays is also limitless. Therefore, for purposes of succinctness and simplicity, subsequent discussion will be confined to a preferred embodiment as it would be employed in an automobile, truck, bus, motorcycle or the like having an internal combustion engine, with limited references being made to other possible embodiments. Additionally, vehicle lighting devices are typically configured as a lamp emitting white light behind a colored lens (a clear lens in the case of headlamps). In the ensuing discussion the words light and lamp are used interchangeably to mean the color of light observed external to the lamp and lens combination. It is not material to achieving the objects of this invention whether this is accomplished by virtue of a lamp and lens combination, or by a lamp emitting the respective color.

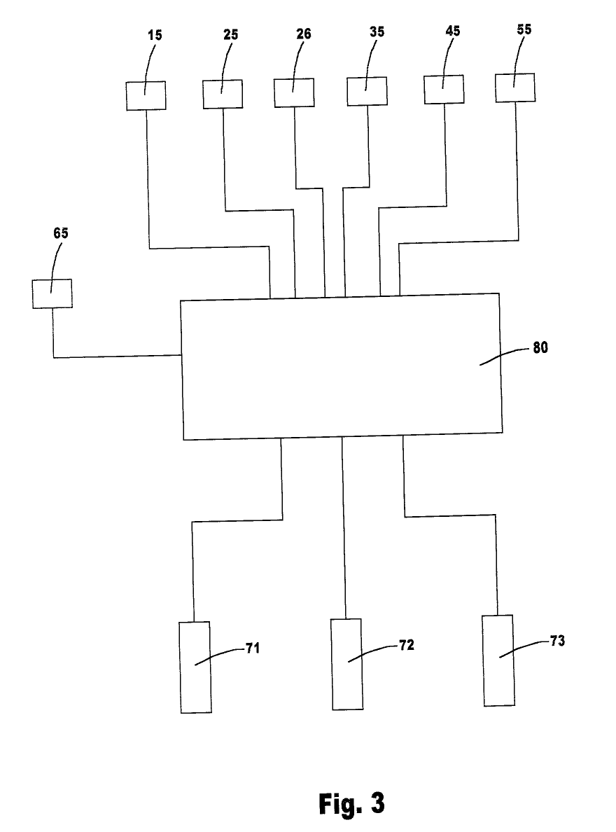

In the preferred embodiment lights for displaying the vehicle's operational state consist of three high-intensity lights in a display housing 70, such as illustrated in FIG. 2, with the following colors and respective meanings for each color, and visible during daylight at least an appropriate distance from a position to the rear of the subject vehicle:

(a) Green light 71, indicating the vehicle is accelerating or moving at a constant velocity;

(b) Yellow light 73, indicating the vehicle is either stopped and idling or decelerating, or the transmission is in neutral or the clutch is disengaged. Note that a vehicle on a steep down slope may actually be accelerating against the dynamic braking effect of engine vacuum (an override condition) in which case also the yellow light will be lit.

(c) Flashing red light 72, indicating the brakes are being applied, the number of flashes per unit of time being indicative of the rate of deceleration due to braking.

The specific colors chosen for the light displays are not material to achieving the objects of the invention except insofar as they are intuitive and universally understood with respect to the existing experience of drivers, and that drivers will instinctively understand the meaning of the displays.

Many other embodiments are possible. There may be a plurality of lights of each color at multiple locations, and the lights may be optically integrated within each other in any combination to achieve desired aesthetics, at the discretion of the vehicle designer and builder. Further, flashing red light 72 may replace the existing brake lights or may be in addition to the conventional red brake lights, again at the discretion of the vehicle designer.

In another possible embodiment, the display devices are signs containing words such as “moving”, “slowing”, “stopping”, “stopped”, etc., which are actuated by a mechanism so as to become visible when the respective operational state is extant. The signs my be combined with lights, or may themselves be lighted.

In a preferred embodiment computer 80 analyzes the outputs from the sensors and controls lights to communicate the operating state of the vehicle. Following is a description of each of the minimum number of states for a vehicle that should be communicated to nearby drivers in the interest of enhancing highway safety. Additional operational states and/or sub-states could also be defined; here again the possibilities are virtually limitless. For simplicity and brevity subsequent discussion will be confined to the operational states defined herein.

Not Operating State—Lights Off: When the vehicle is not operating (engine 10 being shut down) normally the lights are off. However, lights such as parking lights on passenger vehicles and clearance lights on commercial trucks may be on (operating from the vehicle battery), having been manually activated by the vehicle operator by means of a control switch. Such lights may also be under the joint control of computer 80 of this invention as well as the manual control switch, and thus are incorporated in the vehicle safety system.

Stopped and Idling State—Yellow: When engine 10 is idling and the vehicle is not moving: (1) engine speed sensor 15 in cooperation with vacuum sensor 25 and computer 80 determine engine 10 is operating at idle speed and power output, with appropriate distinctions being made for an automatic transmission that is in gear versus in neutral; (2) vehicle speed sensor 45 in cooperation with computer 80 determines the vehicle has zero velocity; (3) the brakes may or may not be on, depending on whether the vehicle automatic transmission is in gear, for example, or whether the vehicle is stopped on a hill and the brakes are required to hold the vehicle in place. Under these conditions computer 80 evaluates the vehicle's operating state to “stopped and idling” and causes yellow light 73 to be illuminated. If the brakes are being applied, however, an override condition is extant and yellow light 73 is off and red light 72 is illuminated continuously; the conventional brake lights, if not incorporated in the safety system, are illuminated also.

Accelerating State—Green: When the operator releases the brakes and activates the throttle control: (1) brake sensor 55 determines the brakes are released; (2) vacuum sensor 25 in cooperation with engine speed sensor 15 and computer 80 determine that engine power and speed are increasing; (3) differential analysis by computer 80 of the output from vehicle speed sensor 45 determines that vehicle speed is increasing. Under these conditions computer 80 evaluates the vehicle's operating state to “accelerating” and causes green light 71 to be illuminated.

Constant Velocity State—Green: When the vehicle has reached cruising speed: (1) engine speed sensor 15 in cooperation with vacuum sensor 25 and computer 80 determine that engine speed and power output are constant; (2) brake sensor 55 determines the brakes are released; (3) differential analysis by computer 80 of the output of vehicle speed sensor 45 determines that the vehicle is maintaining constant speed. Under this set of conditions computer 80 evaluates the vehicle's operating state to “constant velocity” and causes green light 71 to be illuminated.

Decelerating State—Yellow: When the operator releases the accelerator control: (1) engine speed sensor 15 in cooperation with vacuum sensor 25 and computer 80 determine that engine speed and power are decreasing; (2) brake sensor 55 determines the brakes are released; (3) differential analysis by computer 80 of the output of vehicle speed sensor 15 determines the vehicle is decelerating. Under this set of conditions computer 80 evaluates the vehicle's operating state to “decelerating” and causes yellow light 73 to be illuminated.

Braking State—Flashing Red: When the operator applies the vehicle brakes, brake sensor 55 measures the pressure in the braking system and computer 80 looks up the value of the output from brake sensor 55 and compares it to data in a stored data table and selects a flash rate for the red light corresponding to a pressure range. Computer 80 evaluates the vehicle's operating state to “braking” and causes red light 72 to flash at the selected rate, which is proportional to the braking force being applied by the operator, which is in turn is a proxy for the rate of deceleration of the vehicle due to braking.

An alternative approach for determining a flash rate is to use a programmed algorithm that computes a flash rate based on the output signal from brake sensor 55. Either the data table look-up or the algorithm approach accomplishes the object of a determining a flash rate proportional to the deceleration of the vehicle due to braking.

Certain vehicle system conditions take precedence over, and thus override, other conditions and cause the safety system to default to a specific operational state. For example:

If the brakes are applied while the vehicle is accelerating red light 72 flashes and no other warning system light is lit.

If the brakes are applied while the vehicle is stopped and idling red light 72 is illuminated continuously, regardless of input from other sensors. In this operating state the conventional brake lights are also illuminated, or if the conventional brake lights are integrated into the safety system of this invention they are continuously illuminated.

In a vehicle with an automatic transmission, if the transmission is not in a forward gear the system defaults to the stopped and idling state and yellow light 73 is lit.

In a vehicle with a manual transmission and a clutch, if the clutch is disengaged the system defaults to the stopped and idling state and yellow light 73 is lit.

If the vehicle is moving downhill the engine may be providing a dynamic braking effect due to engine vacuum. Vehicle speed and engine speed may be increasing. However, engine vacuum will be high. Under this condition the safety system defaults to deceleration and yellow light 73 will be lit, indicating the vehicle is in neither the accelerating nor the constant velocity state, even though both engine and vehicle speed are increasing.

The Condition-Result Logic tabulation in Table 1 sets forth the parameters and conditions of various vehicle systems that define each operating state and the resulting safety system indication. This table should not be considered an exhaustive list of vehicle systems or their possible operational state, or as applicable to all motor vehicles with which this invention may be used, but rather as a summary of the minimum necessary systems and operating states of a conventional internal combustion engine-powered motor vehicle that are required to define the vehicle's operational state, and communicate information regarding that state to drivers of nearby vehicles. Other types of motor vehicles, for example motorcycles, may have requirements for a different combination of sensors and corresponding computer logic to properly determine and communicate the operational state of the vehicle.

Table 2 correlates the three colored display lights with the operating condition for which the respective display light would be lit and identifies the override conditions. Here again this table should not be construed as an exhaustive list of the possible operational conditions that could be defined, but rather as an example of the operating conditions that could be defined for a preferred embodiment.

TABLE 1
Condition-Result Logic Table

| Vehicle Parameters | | | | | Resultant Light Indication | | |
|---|---|---|---|---|---|---|---|
| | | Throttle | | Transmission/ | | | |
| Engine | Speed | [Optional] | Brakes | Clutch (a) | Green | Yellow | Red (b) |
| N/A | >0 | N/A | Applied | Fwd/Engaged | Off | Off | Flashing |
| N/A | 0 | N/A | Applied | Fwd/Engaged | Off | Off | Continuous |
| Idle | 0 | N/A | Off | Fwd/Engaged | Off | On | Off |
| Idle | >0 | Open | Off | Fwd/Engaged | On | Off | Off |
| P > 0 | >0 | Open | Off | Fwd/Engaged | On | Off | Off |
| P = C | >0 | Open | Off | Fwd/Engaged | On | Off | Off |
| P < 0 | >0 | N/A | Off | Fwd/Engaged | Off | On | Off |
| N/A | >0 | N/A | Off | Neutral/ | Off | On | Off |
| | | | | Disengaged | | | |
| N/A | >0 | N/A | Applied | Neutral/ | Off | Off | Flashing |
| | | | | Disengaged | | | |
| N/A | 0 | N/A | Applied | Neutral/ | Off | Off | Continuous |
| | | | | Disengaged | | | |

Notes to Table 1:
(1) N/A means “Not Applicable”; the value of this parameter is not relevant to evaluating the operating state of the vehicle given the value of other parameters.
(2) P > 0 means engine power and speed are increasing.
(3) P = C means engine power and speed are constant.
(4) P < 0 means engine power is insufficient to accelerate the vehicle; vehicle speed and engine speed may be increasing or decreasing.
(a) “Fwd/Engaged” means a vehicle with an automatic transmission is in a forward gear, or the clutch is engaged in a vehicle with a manual transmission; “Neutral/Disengaged” means a vehicle with an automatic transmission is not in a forward gear, or the clutch is disengaged in a vehicle with a manual transmission.
(b) “Flashing” means red light 72 is flashing at a rate proportional to the vehicle's rate of deceleration due to braking. “Continuous” means the light is illuminated continuously in this operating state.

TABLE 2
Display to Operational Condition Correlation

| Display | Conditions Under Which Display Appears |
|---|---|
| Red-Continuous | (RC) Braking-Brakes applied, vehicle speed zero. |
| | Overrides all other conditions. |
| Red-Flashing | (RF) Braking-Brakes applied, vehicle speed |
| | greater than zero. Flash rate proportional to |
| | pressure in braking system as proxy for rate of |
| | deceleration due to braking. Overrides all other |
| | conditions. |
| Yellow | (Y1) Transmission in other than a forward gear, |
| | or clutch disengaged. Overrides Y2, Y3, Y4, G1 |
| | & G2. |
| | (Y2) Vehicle stopped and idling. Vehicle speed |
| | zero; engine speed and power at idle conditions. |
| | (Y3) Decelerating-Vehicle speed decreasing. |
| | (Y4) Dynamic braking-Vehicle speed increasing, |
| | manifold vacuum high. Overrides G1. |
| Green | (G1) Accelerating-Engine speed, power output, |
| | and vehicle speed increasing. |
| | (G2) Constant Velocity-Engine speed, power |
| | output, and vehicle speed constant. |

While the use of a computer is expected to be the most practical approach for operating the safety system of the present invention it is not the only feasible approach. For example, the sensors could be connected to a bank of electromechanical relays wired in such a way as to effect the desired operation of the displays. Other means for achieving the objects of this invention are undoubtedly possible, limited only by the imagination of the designer. Nevertheless, the innovation and novelty of the present invention—the visual communication of the operating state of a motor vehicle to operators of nearby vehicles—remains the same.

The use of flashing red brake lights is one of the most important aspects of this invention. The characteristic of the flash sequence in terms of time on- versus time off- and on-off cycles per unit of time is not material to achieving the objects of this invention so long as the number of on cycles per unit of time is directly proportional to the rate of deceleration due to braking. Three of the obvious approaches are: (1) Equal lengths for both the on- and off-periods, the number of on-off cycles per unit of time being proportional to the deceleration rate; (2) a fixed length off-period, and variable length on-periods proportional to the vehicle's deceleration rate; or, (3) a fixed length period for the complete on-off cycle, and variable lengths for both the on- and off-periods, wherein the length of the on-period is shorter when deceleration is less and becomes longer when deceleration is greater, the off-period being adjusted accordingly to complete the total period of the on-off cycle.

Details of such things as computer programming and logic design, design of the various sensors of the safety system and their placement and integration into existing vehicle systems will not be discussed in depth herein. Such details will be evident to skilled practitioners of the art of motor vehicle design and computer circuit design, respectively, once the fundamental concept of this invention is grasped. There are many alternative designs of these components and techniques for their integration into existing systems that accomplish the objects of this invention, which can only be considered and determined in the specific context of the vehicle being designed.

The safety system of the present invention can easily be adapted to motor vehicles employing motive power sources of types other than conventional internal combustion engines directly coupled to the wheels. For example, in a hybrid vehicle employing an internal combustion engine in combination with an electric generator, an electric motor, and batteries to store electric power, the vehicle speed sensor and brake system sensor associated with the hydraulic brakes would be the same. However, if the hybrid vehicle also employed an electrical dynamic braking system there would need to be one or more sensors of an appropriate type associated with that braking system and appropriate modifications to the computer logic to fully and correctly evaluate the operational state of the vehicle. Further, the sensors serving the function of monitoring engine speed and power output would need to be of an appropriate type and design, for example the measurement of electric current flowing to the electric motor. Similarly, in a purely electric vehicle employing only an electric motor and batteries, the numbers and types of sensors and the computer logic would require appropriate modifications. Also similarly, a vehicle having a combustion turbine engine, either as a direct power source or in hybrid combination with an electric generator, motor, and batteries, would need a different set of sensors appropriate to the specific design, and corresponding modifications to the computer logic. Nonetheless, here again in each of these example cases and in all other examples that could be cited, the essence of this invention and its innovation and novelty remain the same—namely the visual communication of the operating state of a motor vehicle to operators of nearby vehicles.

The application of the present invention is not limited to passenger-carrying motor vehicles. It is applicable to any motor vehicle licensed to operate on public streets and highways, for example, vans, light trucks, commercial trucks, busses, motorcycles, motor homes, and the like.

### SUMMARY, RAMIFICATIONS AND SCOPE

Accordingly, the reader will see and note that the Vehicle Safety System of the present invention provides significant advantages and a safety promoting system not heretofore available in current practice of motor vehicle lighting systems. Specifically, the present invention:

provides an improved motor vehicle lighting system not heretofore available for motor vehicles operating on public roads and highways;

contributes to the prevention of collisions between motor vehicles;

contributes to the prevention of rear-end collisions in particular;

contributes to the prevention of injuries resulting from collisions and in particular whip-lash injuries resulting from rear-end collisions;

reduces societal costs of injury, pain and suffering, and death to humans;

reduces other societal costs such as: (a) the cost of municipal and state law enforcement, fire and emergency response agencies responding to motor vehicle accidents; (b) the cost of medical care providers and facilities for treating motor vehicle accident victims; (c) the cost of motor vehicle insurance; (d) the cost of motor vehicle repairs; (e) the cost of lost productive time of people recuperating from motor vehicle accidents; and others;

aids in protection of the environment by preventing the release of hazardous materials such as: (a) chlorofluorocarbons in automotive air conditioning systems; (b) ethylene glycol in engine cooling systems; (c) sulfuric acid in lead-acid batteries; (d) petroleum distillates in engine lubrication systems and fuel tanks; (e) polyalkylene glycol ethers in hydraulic braking systems; and others, when these systems rupture following a collision.

provides a lighting system that communicates information about the operational state of the subject vehicle to drivers of nearby vehicles;

communicates to drivers of nearby vehicles that the subject vehicle is stopped and idling;

communicates to drivers of nearby vehicles that the subject vehicle is accelerating;

communicates to drivers of nearby vehicles that the subject vehicle is operating at constant velocity;

communicates to drivers of nearby vehicles that the subject vehicle is decelerating;

communicates to drivers of nearby vehicles that the subject vehicle is braking, and provides a relative indication of the rate of deceleration due to braking.

Although the descriptions and discussions herein contain many specificities, these should not be construed as limiting the scope of the invention, but merely as providing illustrations and examples of some of the presently preferred embodiments of this invention. In consideration of these and other possible adaptations and alterations of the present invention, the invention should be considered broadly, in accordance with the appended claims only, and not solely in accordance with those particular preferred embodiments within which the invention has been taught.

I claim:

1. In a motor vehicle lighting system the improvement wherein said lighting system visually communicates information about an operational state of a motor vehicle to drivers of other vehicles in the vicinity, in combination comprising
(a) a plurality of sensing means to gather data on the state of the component systems of said motor vehicle, and
(b) a plurality of display means to communicate said operational state.

2. The lighting system of claim 1 further comprising computing means to analyze said operational state and control said display means.

3. The lighting system of claim 1 wherein said display means is electric lamps.

4. The lighting system of claim 1 wherein said operational state comprises all possible operational states of a motor vehicle.

5. The lighting system of claim 1 wherein the possible operational states comprise six operational states and wherein said six operational states are defined as
(a) not operating,
(b) stopped and idling,
(c) accelerating,
(d) moving at constant velocity,
(e) decelerating,
(f) braking.

6. The system of claim 5 wherein said braking state is a continuum from minimum braking to locked wheels.

7. The system of claim 5 wherein said display means comprise electric lights and
(a) said not operating state is communicated by said lights being unlit, and,
(b) said stopped and idling state is communicated by a plurality of lights of a first color, and,
(c) said accelerating state is communicated by a plurality of lights of a second color, and,
(d) said moving at constant velocity state is communicated by a plurality of lights of a third color, and,
(e) said decelerating state is communicated by a plurality of lights of a fourth color, and,
(f) said braking state is communicated a plurality of lights of a fifth color.

8. The system of claim 7 wherein one color represents more than one state.

9. The system of claim 7 wherein said lights of said fifth color are flashing.

10. The system of claim 9 wherein the flash rate of said flashing lights communicates information about the rate of deceleration of said vehicle due to said braking.

11. The system of claim 10 wherein said flash rate is directly proportional to the rate of reduction of vehicle velocity due to said braking.

12. The lighting system of claim 1 wherein said operational state is communicated by a plurality of devices which become visible when said state is extant.

13. The system of claim 7 wherein said second color is green, said third color is chosen from the group comprising yellow and amber, and said fifth color is red.

14. The safety system of claim 3 wherein said lights illuminate a plurality of signs indicative of said operational state.

15. The lighting system of claim 1 wherein said display means comprise words which become visible when said operational state is extant.

16. The lighting system of claim 1 further comprising
(a) a vacuum transducer associated with an intake manifold of said vehicle's engine, and
(b) a first tachometer associated with the engine of said vehicle, and
(c) a second tachometer associated with the drive train of said vehicle, and
(d) a pressure transducer associated with the service braking system of said vehicle, and
(e) computing means,
and wherein said vacuum transducer, said first and second tachometers, said pressure transducer, and said position indicator communicate and cooperate with said computing means to determine said operational state and control said display means.

17. The system of claim 16 further comprising a clutch position indicator associated with the clutch operating mechanism of said vehicle, said clutch position indicator communicating and cooperating with said computing means to analyze said operational state and control said display means.

18. A process for operating a computer comprising the steps of
(a) sampling outputs from an engine power output sensor, an engine speed sensor, a vehicle speed sensor, and a brake system pressure sensor, and
(b) analyzing the output from said engine speed sensor to determine if said engine is increasing in speed, operating at constant speed, or decreasing in speed, and
(c) comparing the output from said engine power output sensor to stored data to determine the relative power output of the engine, and
(d) analyzing the output from said vehicle speed sensor to determine if said vehicle is accelerating, operating at constant velocity or decelerating, and
(e) comparing the output from said brake system pressure sensor to stored data to determine the rate of braking of the vehicle, and
(f) logically determining the operational state of said vehicle based on said outputs as one of the states of stopped and idling, accelerating, constant velocity, decelerating, or braking, and
(g) activating display means to communicate said operational state to drivers of nearby vehicles.

19. A process for operating a computer comprising the steps of
(a) sampling outputs from an engine power output sensor, an engine speed sensor, a vehicle speed sensor, and a brake system pressure sensor, and
(b) analyzing the output from said engine speed sensor to determine if said engine is increasing in speed, operating at constant speed, or decreasing in speed, and
(c) applying a first algorithm to the output of said engine power output sensor to determine the relative power output of the engine, and
(d) analyzing the output from said vehicle speed sensor to determine if said vehicle is accelerating, operating at constant velocity or decelerating, and
(e) applying a second algorithm to the output from said brake system pressure sensor to determine the rate of braking of the vehicle, and
(f) logically determining the operational state of said vehicle based on said outputs and said analyses as one of the states of stopped and idling, accelerating, constant velocity, decelerating, or braking, and
(g) activating display means to communicate said operational state to drivers of nearby vehicles.

20. A process for operating a computer comprising the steps of
(a) sampling outputs from an engine power output sensor, an engine speed sensor, a vehicle speed sensor, and a brake system pressure sensor, and
(b) using said output of said engine speed sensor to determine if said engine is increasing in speed, operating at constant speed, or decreasing in speed, and
(c) using said output of said engine power output sensor to determine the relative power output of the engine, and
(d) analyzing the output from said vehicle speed sensor to determine if said vehicle is accelerating, operating at constant velocity or decelerating, and
(e) using said output of said brake system pressure sensor to determine the rate of braking of the vehicle, and
(f) logically determining an operational state of said vehicle based on said outputs as one of the states of stopped and idling, accelerating, constant velocity, decelerating, or braking, and
(g) activating display means to communicate said operational state to drivers of nearby vehicles.
